(19) United States
(12) Patent Application Publication
(10) Pub. No.: US 2026/0081671 A1
(43) Pub. Date: Mar. 19, 2026

(54) METHODS OF CHANNEL QUALITY INDICATION REPORTING WITH TYPE II CODEBOOK FOR HIGH VELOCITY

(71) Applicant: Telefonaktiebolaget LM Ericsson (publ), Stockholm (SE)

(72) Inventors: Siva Muruganathan, Stittsville, Ontario (CA); Xinlin Zhang, Göteborg (SE); Shiwei Gao, Nepean, Ontario (CA); Johan Winges, Göteborg (SE); Keerthi Kumar Nagalapur, Göteborg (SE); Fredrik Athley, Västra Frölunda (SE)

(21) Appl. No.: 19/110,082

(22) PCT Filed: Sep. 29, 2023
(86) PCT No.: PCT/IB2023/059802

§ 371 Date: Mar. 9, 2025

Related U.S. Application Data
(60) Provisional application No. 63/412,017, filed on Sep. 30, 2022.

(51) Int. Cl. H04B 7/06; H04L 5/00

(52) U.S. Cl. CPC H04B 7/0639; H04L 5/0057

(57) ABSTRACT

Systems and methods are disclosed for Channel Quality Indicator (CQI) reporting. In one embodiment, a method performed by a User Equipment (UE) comprises receiving, from a network node, first signaling that indicates a precoding matrix duration in time domain and receiving, from the network node, second signaling that indicates a number of precoder matrix durations wherein each precoder matrix duration is associated with a precoder matrix. The method further comprises receiving, from the network node, third signaling that indicates one or more CQI resolutions in time domain for one or more CQIs. The method further comprises reporting, to the network node, Precoding Matric Indicator (PMI) for the number of precoder matrix durations and reporting, to the network node, one or more CQIs according to the indicated one or more CQI resolutions in time domain. In this manner, feedback of CQI is enabled for, e.g., high-velocity UEs.

### RELATED APPLICATIONS

This application claims the benefit of provisional patent application Ser. No. 63/412,017, filed Sep. 30, 2022, the disclosure of which is hereby incorporated herein by reference in its entirety.

### TECHNICAL FIELD

The present disclosure relates to a cellular communications system and, more specifically, to channel quality indication reporting in a cellular communications system.

### BACKGROUND

### Codebook-Based Precoding

Multi-antenna techniques can significantly increase the data rates and reliability of a wireless communication system. In particular, the performance is improved if both the transmitter and the receiver are equipped with multiple antennas, which results in a Multiple-Input Multiple-Output (MIMO) communication channel. Such systems and/or related techniques are commonly referred to as “MIMO”.

The 3^{rd} Generation Partnership Project (3GPP) New Radio (NR) standard is currently evolving with enhanced MIMO support. A core component in NR is the support of MIMO antenna deployments and MIMO related techniques like, for instance spatial multiplexing. The spatial multiplexing mode is aimed for high data rates in favorable channel conditions. An illustration of the spatial multiplexing operation is provided in FIG. 1.

FIG. 1 illustrates an example of a transmission structure of precoded spatial multiplexing mode in NR. As seen, the information carrying symbol vector s is multiplied by an N_{T}×r precoder matrix W, which serves to distribute the transmit energy in a subspace of the N_{T} (corresponding to N_{T} antenna ports) dimensional vector space. The precoder matrix is typically selected from a codebook of possible precoder matrices, and typically indicated by means of a Precoder Matrix Indicator (PMI), which specifies a unique precoder matrix in the codebook for a given number of symbol streams. The r symbols in s each correspond to a layer and r is referred to as the transmission rank. In this way, spatial multiplexing is achieved since multiple symbols can be transmitted simultaneously over the same Time/Frequency Resource Element (TFRE). The number of symbols r is typically adapted to suit the current channel properties.

NR uses Orthogonal Frequency Division Multiplexing (OFDM) in the downlink (and Discrete Fourier Transform (DFT) precoded OFDM in the uplink for rank-1 transmission) and hence the received N_{R}×1 vector yₙ for a certain TFRE on subcarrier n (or alternatively data TFRE number n) is thus modeled by

$${y}_{n} = {H}_{n} {Ws}_{n} + {e}_{n}$$

where eₙ is a noise/interference vector obtained as realizations of a random process. The precoder W can be a wideband precoder, which is constant over frequency, or frequency selective.

The precoder matrix W is often chosen to match the characteristics of the N_{R}×N_{T} MIMO channel matrix Hₙ, resulting in so-called channel dependent precoding. This is also commonly referred to as closed-loop precoding and essentially strives for focusing the transmit energy into a subspace which is strong in the sense of conveying much of the transmitted energy to the UE.

In closed-loop precoding for the NR downlink, the User Equipment (UE) transmits, based on channel measurements in the downlink, recommendations to the gNodeB (gNB) of a suitable precoder to use. The gNB configures the UE to provide feedback according to CSI-ReportConfig and may transmit Channel State Information Reference Signal (CSI-RS) and configure the UE to use measurements of CSI-RS to feed back recommended precoding matrices that the UE selects from a codebook. A single precoder that is supposed to cover a large bandwidth (wideband precoding) may be fed back. It may also be beneficial to match the frequency variations of the channel and instead feed back a frequency-selective precoding report, e.g., several precoders, one per subband. This is an example of the more general case of Channel State Information (CSI) feedback, which also encompasses feeding back other information than recommended precoders to assist the gNB in subsequent transmissions to the UE. Such other information may include Channel Quality Indicators (CQIs) as well as transmission Rank Indicator (RI). In NR, CSI feedback can be either wideband, where one CSI is reported for the entire channel bandwidth, or frequency-selective, where one CSI is reported for each subband, which is defined as a number of contiguous resource blocks ranging between 4-32 Physical Resource Blocks (PRBs) depending on the Band Width Part (BWP) size.

Given the CSI feedback from the UE, the gNB determines the transmission parameters it wishes to use to transmit to the UE, including the precoding matrix, transmission rank, and Modulation and Coding Scheme (MCS). These transmission parameters may differ from the recommendations the UE makes. The transmission rank, and thus the number of spatially multiplexed layers, is reflected in the number of columns of the precoder W. For efficient performance, it is important that a transmission rank that matches the channel properties is selected.

With Multi-User MIMO (MU-MIMO), two or more users in the same cell are co-scheduled on the same time-frequency resource(s). That is, two or more independent data streams are transmitted to different UEs at the same time, and the spatial domain can typically be used to separate the respective streams. By transmitting several streams simultaneously, the capacity of the system can be increased. This, however, comes at the cost of reducing the SINR per stream, as the power must be shared between streams and the streams will cause interference to each other.

### Channel State Information Reference Signals (CSI-RS)

For CSI measurement and feedback, CSI-RS are defined. A CSI-RS is transmitted on each antenna port and is used by a UE to measure downlink channel between each of the transmit antenna ports and each of the UE's receive antenna ports. The transmit antenna ports are also referred to as CSI-RS ports. The supported number of antenna ports in NR are {1, 2, 4, 8, 12, 16, 24, 32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain REs in a slot and certain slots. FIG. 2 shows an example of CSI-RS Resource Elements (REs) for 12 antenna ports, where 1 RE per Resource Block (RB) per port is shown. FIG. 2 illustrates an example of RE allocation for a 12-port CSI-RS in NR.

In addition, Interference Measurement Resource (IMR) is also defined in NR for a UE to measure interference. An IMR resource contains 4 REs, either 4 adjacent RE in frequency in the same OFDM symbol or 2-by-2 adjacent REs in both time and frequency in a slot. By measuring both the channel based on NZP CSI-RS and the interference based on an IMR, a UE can estimate the effective channel and noise plus interference to determine the CSI, i.e., rank, precoding matrix, and the channel quality. Furthermore, a UE in NR may be configured to measure interference based on one or multiple NZP CSI-RS resource.

### CSI Framework in NR

In NR, a UE can be configured with multiple CSI reporting settings and multiple CSI-RS resource settings. Each resource setting can contain multiple resource sets, and each resource set can contain up to eight CSI-RS resources. For each CSI reporting setting, a UE feeds back a CSI report.

Each CSI reporting setting contains at least the following information:
A CSI-RS resource set for channel measurement
Optionally, a CSI-RS resource set for interference measurement
Time-domain behavior, i.e., periodic, semi-persistent, or aperiodic reporting
Frequency granularity, i.e., wideband or subband
CSI parameters to be reported such as RI, PMI, Channel Quality Indicator (CQI), and CSI-RS resource indicator (CRI) in case of multiple CSI-RS resources in a resource set
Codebook types, i.e., type I or II, and codebook subset restriction
Measurement restriction.
Subband size. One out of two possible subband sizes is indicated, the value range depends on the bandwidth of the BWP. One CQI/PMI (if configured for subband reporting) is fed back per subband).

When the CSI-RS resource set in a CSI reporting setting contains multiple CSI-RS resources, one of the CSI-RS resources is selected by a UE and a CRI is also reported by the UE to indicate to the gNB about the selected CSI-RS resource in the resource set, together with RI, PMI, and CQI associated with the selected CSI-RS resource.

For aperiodic CSI reporting in NR, more than one CSI reporting settings, each with a different CSI-RS resource set for channel measurement and/or resource set for interference measurement can be configured and triggered at the same time. In this case, multiple CSI reports are aggregated and sent from the UE to the gNB in a single PUSCH.

### Type I and Type II Codebooks in NR

Type I codebook (CB) is typically used by a UE to report CSI for single user MIMO (SU-MIMO) scheduling in NR, while Type II CB is typically for more accurate CSI feedback for multi-user MIMO (MU-MIMO) scheduling.

For both Type I and Type II CBs, for each rank, a precoding matrix W is defined in the form of

$$W = {W}_{1} {W}_{2}$$

where

$${W}_{1} = [ \begin{matrix}{d}_{1} & {d}_{2} & … & {d}_{L} & 0 & 0 & … & 0 \\ 0 & 0 & … & 0 & {d}_{1} & {d}_{2} & … & {d}_{L}\end{matrix} ]$$

is a 2N×2L matrix and contains information of L selected DFT beams {dᵢ, i=1, . . . , L}, where dᵢ is a N×1 DFT vector and N is the number of CSI-RS ports per polarization; while W₂ is a 2L×v matrix and contains the co-phasing coefficients between the selected beams and also between antenna ports with two different polarizations, where v is the number of layers or rank. W₁ is the same for the whole CSI bandwidth while W₂ can be for the whole bandwidth or per subband.

In case of Type I CB, the precoding vector for each MIMO layer is associated with a single DFT beam. While for Type II CB, the precoding vector for each layer is a linear combination of multiple DFT beams.

### Enhanced Type II Codebook in NR

In NR Rel-16, the Type II codebook is enhanced by applying frequency domain (FD) compression across all subbands to reduce CSI feedback overhead and/or improve CSI accuracy. Instead of reporting W₂ for each subband, linear combinations of DFT basis vectors are used to jointly represent W₂ across the whole CSI bandwidth. For each layer, a precoding matrix W across all subbands is in the form

$$W = {W}_{1} {{\tilde{W}}^{′}}_{2} {{W}^{H}}_{f}$$

where W_{f}=[f₁, . . . , f_{M}] is a matrix containing M selected DFT basis vectors {f₁, . . . , f_{M}}, \tilde{W}′₂ is 2L×M matrix containing the coefficients for each selected DFT beam and each selected FD basis vector.

In order to save reporting overhead and since some coefficients in \tilde{W}′₂ typically are weak, only a subset of K_{NZ,i}≤K₀<2LMᵢ non-zero coefficients (NZCs) are reported for each layer i. The 2LMᵢ−K_{NZ,i} non-reported coefficients are assumed to be zero. The maximum number of non-zero coefficients per layer is K₀=[β×2LM₀] where

$$β ∈ \{ \frac{1}{4} , \frac{1}{2} , \frac{3}{4} \}$$

is Radio Resource Control (RRC) configured. For RI={2,3,4}, the total maximum number of NZC across all layers is ≤2 Kg. In order for the gNB to know which coefficients in \tilde{W}′₂ that have been selected, a bitmap of size 2LMᵢ for each layer i is used to indicate in the NZC for that layer.

### Enhanced Type II Codebook for High/Medium UE Velocities

It has been observed in measurements in real deployments that downlink MU-MIMO precoding performance degrades when one or more of the co-scheduled UEs start to move faster than a few kilometers per hour (km/h) relative to the base station. One of the main reasons is that the information of the channels, used to compute the MIMO precoding at the base station, becomes outdated rather soon when this occurs. As a result, the precoder loses its effectiveness to protect co-scheduled users from interference when transmitting to an intended user. Hence, downlink MU-MIMO precoding needs to be made robust to higher UE speeds.

One solution to mitigate this problem and to cope with such rapid channel variations is to configure faster CSI reporting (i.e., more frequent CSI reporting and measurement). A problem with this approach is that this incurs a large signaling and reporting overhead. Furthermore, even if the CSI-RS periodicity is increased, there is still a CSI reporting and scheduling delay that may cause the reported CSI to become outdated. Hence, with the current CSI framework in NR, it is difficult to obtain accurate CSI for medium-to-high-speed UEs with a reasonable amount of overhead.

It has been agreed in the 3GPP Rel-18 work item on MIMO Evolution for Downlink and Uplink (see, e.g., 3GPP RP-213598) to specify CSI reporting enhancement for high/medium UE velocities by exploiting time-domain correlation/Doppler-domain information to assist downlink (DL) precoding. In particular, Rel-16/17 Type-II codebook refinement, without modification to the spatial and frequency domain basis, should be investigated.

The following agreement regarding the new Type II codebook structure for high/medium UE velocities was made in RAN1 #110 (see, e.g., RAN1 Chair's Notes, 3GPP TSG RAN WG1 #110, Toulouse, France, Aug. 22-26, 2022):
For the Rel-18 Type-II codebook refinement for high/medium velocities, down-select one from the following codebooks structures:
   Alt2A: Doppler-domain basis commonly selected for all SD/FD bases, e.g., W₁\tilde{W}₂(W_{f}⊗W_{d})^{H}
      Note that W_{d} may be the identity as a special case
   Alt2B: Doppler-domain basis independently selected for different SD/FD bases
      Note that W_{d} may be the identity as a special case.
   Alt3. Reuse Rel-16/17 (F)eType-II codebook with multiple \tilde{W}₂ and a single W₁ and W_{f} report.

In the agreement made in RAN1 #110, Alt3 may result in a large CSI overhead if a large number of \tilde{W}₂s are included in the CSI report since Alt3 corresponds to the case with no Doppler domain compression. On the other hand, the two variants of Alt2 (i.e., Alt2A and Alt2B) provide the possibility for Doppler domain compression by introducing the matrix W a. To attain compression in the Doppler domain, the matrix W_{d} may contain one or more selected Doppler domain basis vectors. Note that the Doppler domain basis vectors are agreed to be DFT basis vectors in RAN1.

It was also further agreed in 3GPP RAN1 #110 to introduce a Doppler domain (DD)/Time domain (TD) Time Unit (TU) parameter as a codebook parameter for the Rel-18 Type-II codebook for high/medium velocities. A time unit defines the resolution in time domain for which a PMI is fed back. For instance, in Rel-18 Type-II codebook for high/medium velocity, the UE may be requested to feedback PMIs for N_{PMI} different time units. The PMIs over the N_{PMI} time units may be represented by a few DD/TD basis vectors and fed back jointly as part of CSI report.

### SUMMARY

Systems and methods are disclosed for Channel Quality Indicator (CQI) reporting. In one embodiment, a method performed by a User Equipment (UE) comprises receiving, from a network node, first signaling that indicates a precoding matrix duration in time domain and receiving, from the network node, second signaling that indicates a number of precoder matrix durations wherein each precoder matrix duration is associated with a precoder matrix. The method further comprises receiving, from the network node, third signaling that indicates one or more CQI resolutions in time domain for one or more CQIs. The method further comprises reporting, to the network node, Precoding Matric Indicator (PMI) for the number of precoder matrix durations and reporting, to the network node, one or more CQIs according to the indicated one or more CQI resolutions in time domain. In this manner, feedback of CQI is enabled for, e.g., high-velocity UEs.

In one embodiment, the third signaling is independent from the first signaling.

In one embodiment, the precoding matrix duration in time domain is defined in terms of an integer number of slots.

In one embodiment, each of the indicated one or more CQI resolutions in time domain is defined over two precoding matrix durations in time domain.

In one embodiment, reporting the one or more CQIs comprises reporting one wideband CQI for each of the indicated one or more CQI resolutions in time domain.

In one embodiment, reporting the one or more CQIs comprises reporting one wideband CQI and a plurality of subband CQIs for each of the indicated one or more CQI resolutions in time domain.

In one embodiment, each of the indicated one or more CQI resolutions in time domain is defined over the number of precoder matrix durations in time indicated by the second signaling.

Corresponding embodiments of a UE are also disclosed. In one embodiment, a UE is adapted to receive, from a network node, first signaling that indicates a precoding matrix duration in time domain and receive, from the network node, second signaling that indicates a number of precoder matrix durations wherein each precoder matrix duration is associated with a precoder matrix. The UE is further adapted to receive, from the network node, third signaling that indicates one or more CQI resolutions in time domain for one or more CQIs. The UE is further adapted to report, to the network node, PMI for the number of precoder matrix durations and report, to the network node, one or more CQIs according to the indicated one or more CQI resolutions in time domain.

In another embodiment, a UE comprises a communication interface and processing circuitry associated with the communication interface. The processing circuitry is configured to cause the UE to receive, from a network node, first signaling that indicates a precoding matrix duration in time domain and receive, from the network node, second signaling that indicates a number of precoder matrix durations wherein each precoder matrix duration is associated with a precoder matrix. The processing circuitry is further configured to cause the UE to receive, from the network node, third signaling that indicates one or more CQI, Channel Quality Indicator, resolutions in time domain for one or more CQIs. The processing circuitry is further configured to cause the UE to report, to the network node, PMI for the number of precoder matrix durations and report, to the network node, one or more CQIs according to the indicated one or more CQI resolutions in time domain.

Embodiments of a method performed by a network node of a cellular network are also disclosed. In one embodiment, a method performed by a network node of a cellular network comprises transmitting, to a UE, first signaling that indicates a precoding matrix duration in time domain and transmitting, to the UE, second signaling that indicates a number of precoder matrix durations wherein each precoder matrix duration is associated with a precoder matrix. The method further comprises transmitting, to the UE, third signaling that indicates one or more CQI resolutions in time domain for one or more CQIs. The method further comprises receiving, from the UE, PMI reported for the number of precoder matrix durations and receiving, from the UE, one or more CQIs reported according to the indicated one or more CQI resolutions in time domain.

In one embodiment, the third signaling is independent from the first signaling.

In one embodiment, the precoding matrix duration in time domain is defined in terms of an integer number of slots.

In one embodiment, each of the indicated one or more CQI resolutions in time domain is defined over two precoding matrix durations in time domain.

In one embodiment, receiving the one or more CQIs comprises receiving one wideband CQI for each of the indicated one or more CQI resolutions in time domain.

In one embodiment, receiving the one or more CQIs comprises receiving one wideband CQI and a plurality of subband CQIs for each of the indicated one or more CQI resolutions in time domain.

In one embodiment, each of the indicated one or more CQI resolutions in time domain is defined over the number of precoder matrix durations in time indicated by the second signaling.

Corresponding embodiments of a network node for a cellular network are also disclosed. In one embodiment, a network node for a cellular network is adapted to transmit, to a UE, first signaling that indicates a precoding matrix duration in time domain and transmit, to the UE, second signaling that indicates a number of precoder matrix durations wherein each precoder matrix duration is associated with a precoder matrix. The network node is further adapted to transmit, to the UE, third signaling that indicates one or more CQI resolutions in time domain for one or more CQIs. The network node is further adapted to receive, from the UE, PMI reported for the number of precoder matrix durations and receive, from the UE, one or more CQIs reported according to the indicated one or more CQI resolutions in time domain.

In another embodiment, a network node for a cellular network comprises processing circuitry configured to cause the network node to transmit, to a UE, first signaling that indicates a precoding matrix duration in time domain and transmit, to the UE, second signaling that indicates a number of precoder matrix durations wherein each precoder matrix duration is associated with a precoder matrix. The processing circuitry is further configured to cause the network node to transmit, to the UE, third signaling that indicates one or more CQI resolutions in time domain for one or more CQIs. The processing circuitry is further configured to cause the network node to receive, from the UE, PMI reported for the number of precoder matrix durations and receive, from the UE, one or more CQIs reported according to the indicated one or more CQI resolutions in time domain.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a transmission structure of precoded spatial multiplexing mode in New Radio (NR);

FIG. 2 illustrates an example of Resource Element (RE) allocation for a 12-port Channel State Information Reference Signal (CSI-RS) in NR;

FIG. 3A shows an example for the case of R_{CQI}=2 where a Channel Quality Indicator (CQI) Time Unit (TU) has twice the duration of a Precoding Matrix Indicator (PMI) TU, in accordance with an example embodiment of the present disclosure;

FIG. 3B illustrates an example of a special case in which R_{CQI} chosen to be the same as N_{PMI}, in accordance with an example embodiment of the present disclosure;

FIG. 3C illustrates an example of the performance gains in terms of cell-edge user throughout compared to Rel-16 Type II Channel State Information (CSI) codebook between R_{CQI}=N_{PMI} and R_{CQI}=1;

FIG. 4A illustrates a method performed by a User Equipment (UE) according to some embodiments of the disclosure;

FIG. 4B illustrates a method performed by a UE according to an alternative embodiment of the disclosure;

FIG. 5A illustrates a method performed by a network node according to some embodiments of the disclosure;

FIG. 5B illustrates a method performed by a network node according to an alternative embodiment of the disclosure;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host, which may be an embodiment of the host of FIG. 6, in accordance with various aspects described herein;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

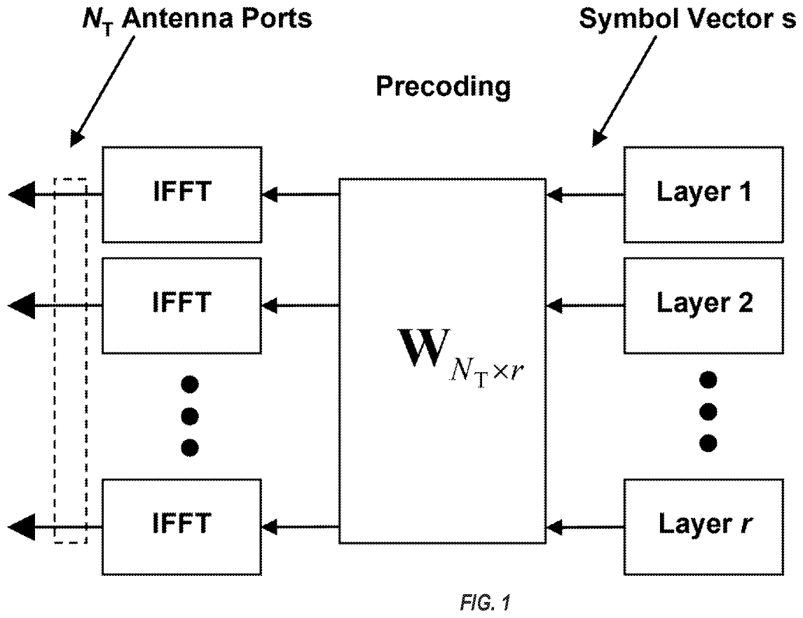

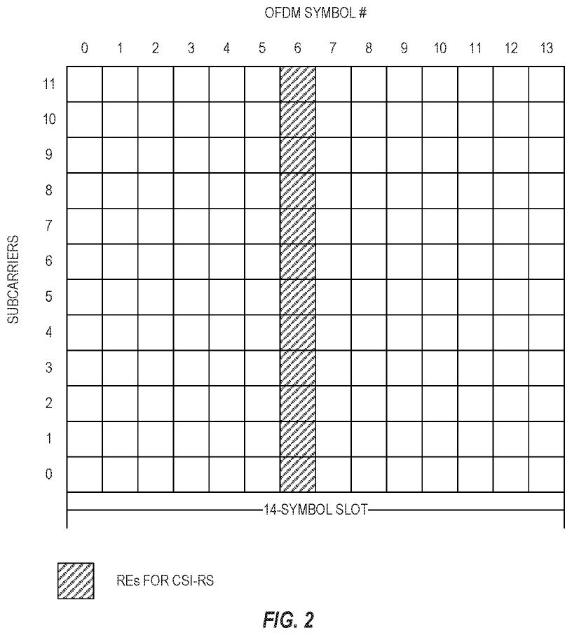

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). Although it is agreed in 3^{rd} Generation Partnership Project (3GPP) to feedback Precoding Matrix Indicator (PMI) (e.g., compressed PMI) corresponding to multiple time units, how to feedback Channel Quality Indicator (CQI) for the Rel-18 Type-II codebook for high/medium velocities is still an open issue.

Certain aspects of the disclosure and their embodiments may provide solutions to these or other challenges. Some embodiments of the current disclosure provide methods and devices including one or more of the following, in any combination:
definition of a CQI time unit defined using the PMI time unit.
an integer parameter is used to scale the PMI time unit in order to derive the CQI time unit
   the integer parameter may be signaled/configured/indicated by the gNodeB (gNB) to the User Equipment (UE), or
   the integer parameter may be selected and reported by the UE as part of Channel State Information (CSI) report
reporting of one wideband CQI per CQI time unit
reporting of a configured number of subband CQIs for a CQI time unit
reporting of wideband CQI and a number of configured subband CQIs for the first CQI time unit, and reporting only wideband CQIs for the remaining CQI time units
reporting the wideband CQI corresponding to the first CQI time unit as an absolute value, and reporting the remaining wideband CQIs and subband CQIs as relative or differential values with respect to the wideband CQI corresponding to the first CQI time unit

Certain embodiments may provide one or more of the following technical advantage(s). Some embodiments of this disclosure may allow solutions on how to feedback CQI for Type II codebook for high velocity. Some embodiments of this disclosure may provide a flexible way to report how many CQIs need to be feedback when reporting PMIs corresponding to multiple PMI time units. Some embodiments of this disclosure may provides solutions to cover cases where the gNB can control how many CQIs are fed back by the UE and where the UE determines the number of CQIs to feedback.

### CQI Time Units

In one embodiment, the UE receives from the gNB an indication/configuration/signaling of one or more of the following:
a length of the time unit which defines the resolution of the PMI (referred to as PMI time unit, or PMI TU henceforth) in time domain; the PMI TU may be defined in terms of a number of slots (e.g., 1 PMI TU=1 slot, or 1 PMI TU=2 slots, etc.), a number of Orthogonal Frequency Division Multiplexing (OFDM) symbols (e.g., 1 PMI TU=14 symbols, or 1 PMI TU=7 symbols, etc.);
a number of PMI TUs for which the UE is requested to feedback PMIs; the number of PMI TUs is denoted herein as N_{PMI}.

In some embodiments, the nominal number of Time Domain (TD)/Doppler Domain (DD) components is given by

$$ceil ( p * \frac{{N}_{PMI}}{{R}_{CQI}} ) ,$$

where p is indicated in a parameter combination signaled from the network to the UE.

In some embodiments, the length of PMI TU may be predefined in 3GPP specifications and does not need to be signaled from the gNB to the UE.

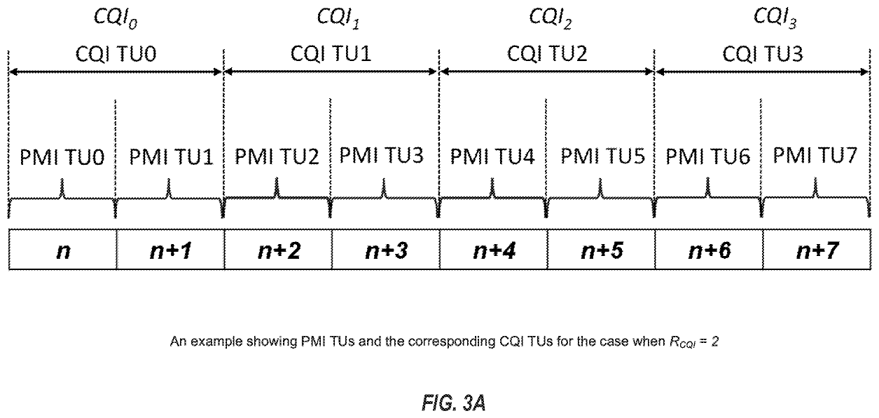

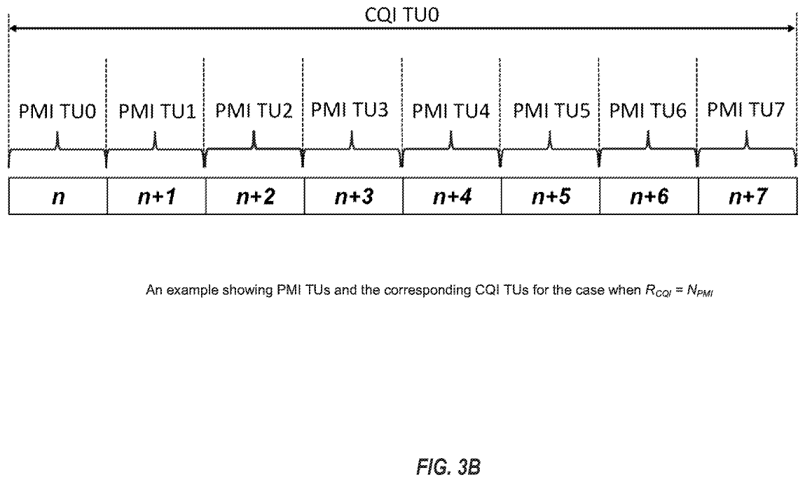

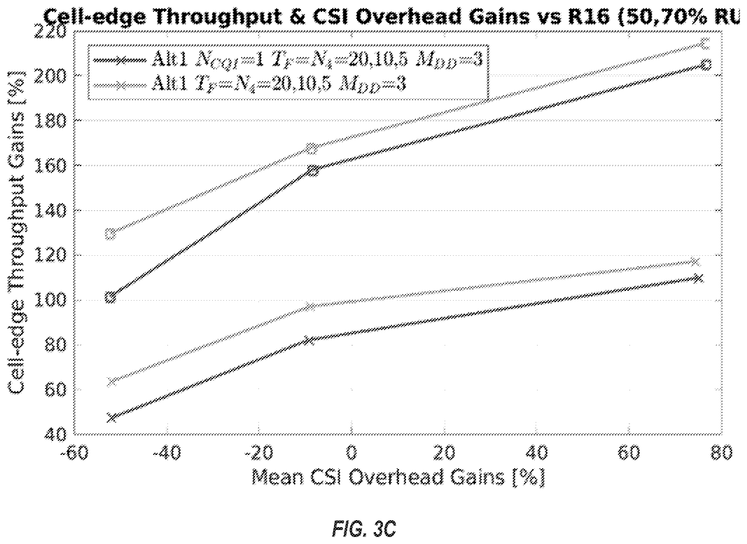

In one embodiment, the resolution of the CQI in time domain (referred to as CQI time unit, or CQI TU) is defined wherein the length of the CQI TU is defined as:

$$CQI TU = {R}_{CQI} \times PMI TU$$

where in a R_{CQI} is a positive integer value integer. FIG. 3A shows an example for the case of R_{CQI}=2 where a CQI TU has twice the duration of a PMI TU. In the figure, the number of PMI TUs is assumed to be N_{PMI}=8 and each box in the figure represents a PMI TU. As shown in the figure, the following CQI TUs are defined:
CQI TU 0 is defined over the duration of PMI TU0 and PMI TU1,
CQI TU 1 is defined over the duration of PMI TU2 and PMI TU3,
CQI TU 2 is defined over the duration of PMI TU4 and PMI TU5,
CQI TU 3 is defined over the duration of PMI TU6 and PMI TU7

In one embodiment, R_{CQI} is configured/indicated/signaled by the gNB to the UE. In some embodiments, R_{CQI} is configured as part of CSI reporting configuration or codebook configuration that the gNB configures to the UE. In another embodiment, the value of R_{CQI} is selected by the UE and reported as part of the CSI report. In some other embodiments, RCQI may be signaled to the UE via a combination of one or more of RRC, Medium Access Control (MAC) Control Element (CE) signaling, and Downlink Control Information (DCI) signaling. In some embodiments, R_{CQI} is indicated as part of a parameter combination.

In some embodiments, the value of R_{CQI} is layer common.

In an alternative embodiment, CQI TU and PMI TU are independently signaled by the network to the UE.

### CQIs Reported Per CQI Time Unit

In one embodiment, one wideband CQI is computed and reported per each CQI TU. In this embodiment, the number of wideband CQIs reported is N_{PMI}/R_{CQI}. And all these N_{PMI}/R_{CQI} wideband CQIs are reported jointly as part of the CSI report. In another embodiment, one of the wideband CQIs (e.g., wideband CQI corresponding to CQI TU0) is reported as an absolute value using N_{CQI,abs} bits to quantize the absolute value. The remaining (N_{PMI}/R_{CQI}−1) wideband CQIs are reported as differential or relative value with respect to the first wideband CQI (e.g., the one corresponding to CQI TU 0) that is reported as absolute value. A fewer number N_{CQI,rel} of bits are used to quantize each relative wideband CQI value where N_{CQI,rel}<N_{CQI,abs}.

In another embodiment, one wideband CQI and a number of subband CQIs are computed for a CQI TU. The number of subband CQIs to be reported for the CQI TU is configured by the gNB to the UE. The subband CQIs are reported as differential or relative value with respect to the first wideband CQI (e.g., the one corresponding to CQI TU 0) that is reported as absolute value. A fewer number N′_{CQI,rel} of bits are used to quantize each relative subband CQI value where N′_{CQI,rel}<N_{CQI,abs}. In some embodiments, the number of bits used to quantize each relative subband CQI value is the same as the number of bits used to quantize each relative wideband CQI value (i.e., N′_{CQI,rel}=N_{CQI,rel}).

In another embodiment, for CQI TU 0, both wideband CQI and a number of subband CQIs are reported. For the remaining CQI TUs, only wideband CQI is reported.

In one special case, R_{CQI} chosen to be the same as N_{PMI}. This special case is illustrated in FIG. 3B. In this case, the number of CQI TUs is 1 (i.e., only CQI TU0 is present). In this case, the UE may feedback a single wideband CQI and a configured number of subband CQIs for CQI TU0.

An example of the performance gains in terms of cell-edge user throughout compared to Rel-16 Type II CSI codebook between R_{CQI}=N_{PMI} and R_{CQI}=1 is shown in FIG. 3C. FIG. 3C illustrates cell-edge UE Throughput (UTP) Gain versus Overhead comparison of a Type II CB with N_{PMI}=N₄ PMIs (using MDD=3 DFT bases) feedback every T_{F}=N_{PMI} slot with a Rel-16 Type II CB for a scenario with 16Tx/2Rx at 50% and 70% RU. R_{CQI} comparison in terms of N_{CQI}=1 for R_{CQI}=N_{PMI} (lines 1 and 3 from bottom up) and N_{CQI}=N_{PMI} for R_{CQI}=1 (lines 2 and 4 from bottom up), according to some embodiments of the disclosure.

In some embodiments, when R_{CQI} is chosen to be the same as N_{PMI}, the single CQI is based on the CQIs corresponding to all the reported PMIs.

In some embodiments, in the single CQI that is fed back, CQI of a subband is determined as the minimum of the subband-CQIs of all PMIs for that subband. i.e., the CQI of subband k is determined as

$${CQI}_{reported} ( k ) = {min}_{n} ( CQI ( n , k ) )$$

where CQI(n, k) is the CQI for PMI n and subband k.

Although the term gNB is used in the above description, the term gNB may generalized to a network node that configures the UE for CSI reporting and receives CSI reporting from the UE.

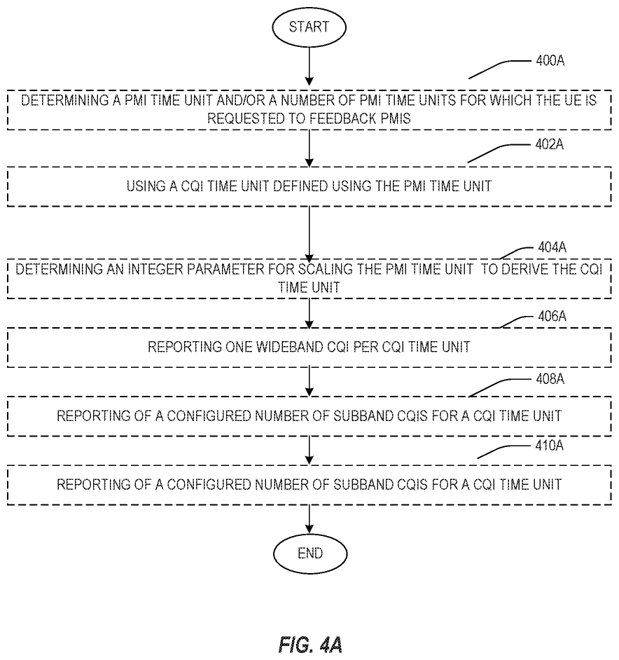

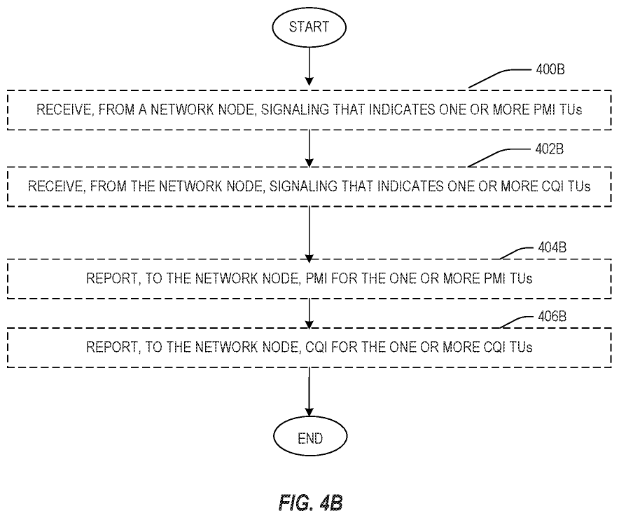

FIG. 4A illustrates a method performed by a UE according to some embodiments of the disclosure. The method includes one or more of: determining (400A) a PMI time unit and/or a number of PMI time units for which the UE is requested to feedback PMIs; using (402A) a CQI time unit defined using the PMI time unit; determining (404A) an integer parameter for scaling the PMI time unit to derive the CQI time unit; reporting (406A) one wideband CQI per CQI time unit; reporting (408A) of a configured number of subband CQIs for a CQI time unit; and/or reporting (410A) of a configured number of subband CQIs for a CQI time unit. The steps can be performed in any combination and in any order.

As discussed above, in an alternative embodiment, CQI TU and PMI TU are independently signaled by the network to the UE. In this regard, FIG. 4B illustrates a method performed by a UE in accordance with this alternative embodiment. As illustrated, the UE receives, from a network node, signaling that indicates one or more PMI TUs (e.g., a PMI TU duration and a number of PMI TUs) (step 400B) and signaling that indicates one or more CQI TUs (step 402B). In other words, the PMI TU(s) and the CQI TU(s) are signaled independently from one another. The UE reports PMI for the one or more PMI TUs (step 404B) and reports CQI for the one or more CQI TUs (step 406B). Various embodiments relate to the reported CQI are described above. For example, in one embodiment, one wideband CQI is computed and reported per each CQI TU. As another example, in one embodiment, one wideband CQI and a number of subband CQIs are computed for a CQI TU.

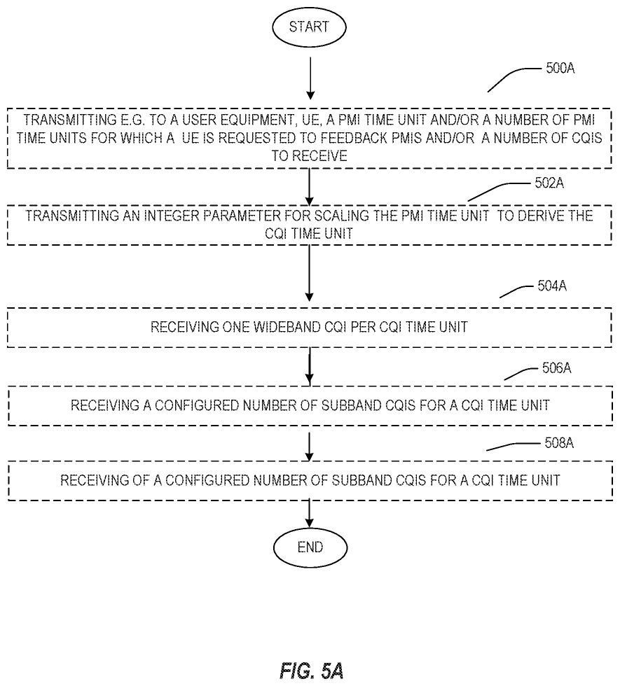

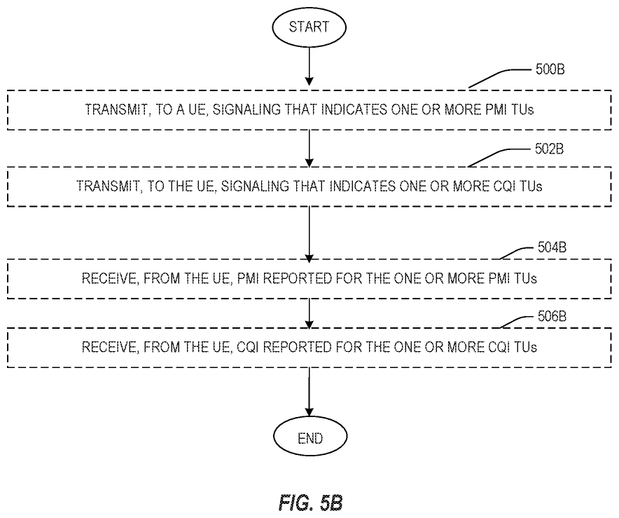

FIG. 5A illustrates a method performed by a network node according to some embodiments of the disclosure. The method includes one or more of: transmitting (step 500A) a PMI time unit and/or a number of PMI time units for which a user equipment is requested to feedback PMIs; transmitting (step 502A) an integer parameter for scaling the PMI time unit to derive the CQI time unit; receiving (step 504A) one wideband CQI per CQI time unit; receiving (step 506A) a configured number of subband CQIs for a CQI time unit; and/or receiving (step 508A) of a configured number of subband CQIs for a CQI time unit. The steps can be performed in any combination and in any order.

As discussed above, in an alternative embodiment, CQI TU and PMI TU are independently signaled by the network to the UE. In this regard, FIG. 5B illustrates a method performed by a network node in accordance with this alternative embodiment. As illustrated, the network node transmits, to a UE, signaling that indicates one or more PMI TUs (e.g., a PMI TU duration and/or a number of PMI TUs) (step 500B) and signaling that indicates one or more CQI TUs (step 502B). In other words, the PMI TU(s) and the CQI TU(s) are signaled independently from one another. The network node receives, from the UE, PMI reported for the one or more PMI TUs (step 504B) and CQI reported for the one or more CQI TUs (step 506B). Various embodiments relate to the reported CQI are described above. For example, in one embodiment, one wideband CQI is computed and reported per each CQI TU. As another example, in one embodiment, one wideband CQI and a number of subband CQIs are computed for a CQI TU.

FIG. 6 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access node or non-3GPP Access Point (AP). The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602 and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRA-) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

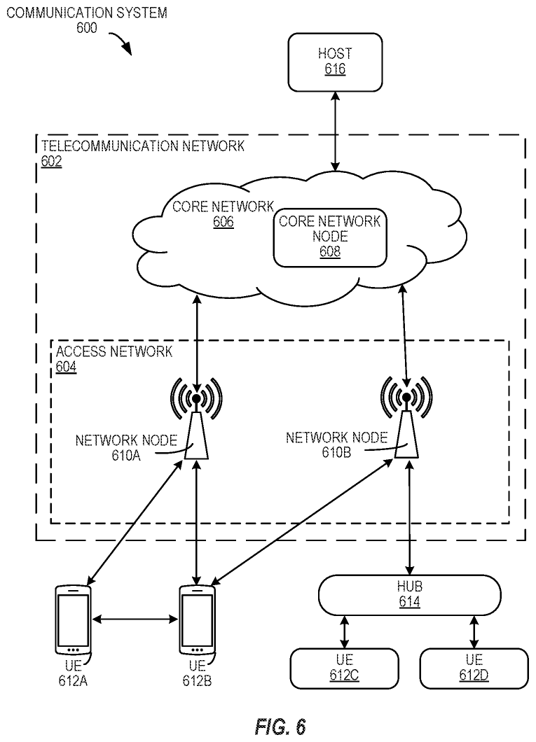

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM),

Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

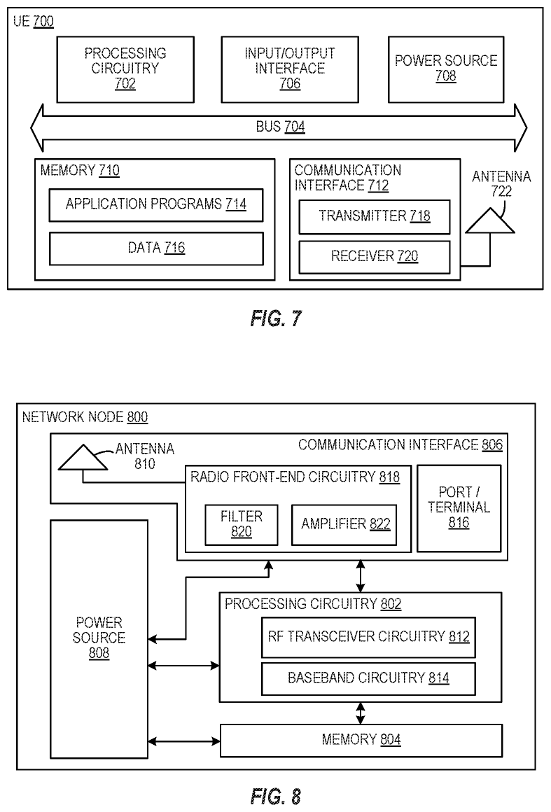

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

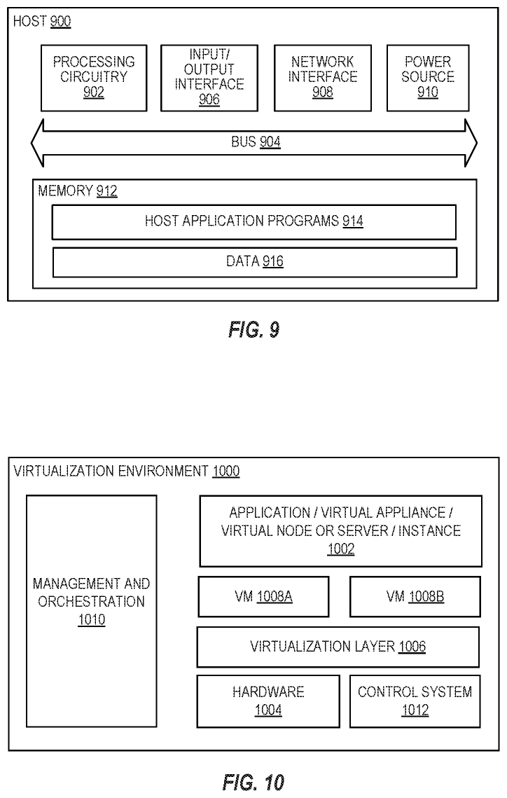

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

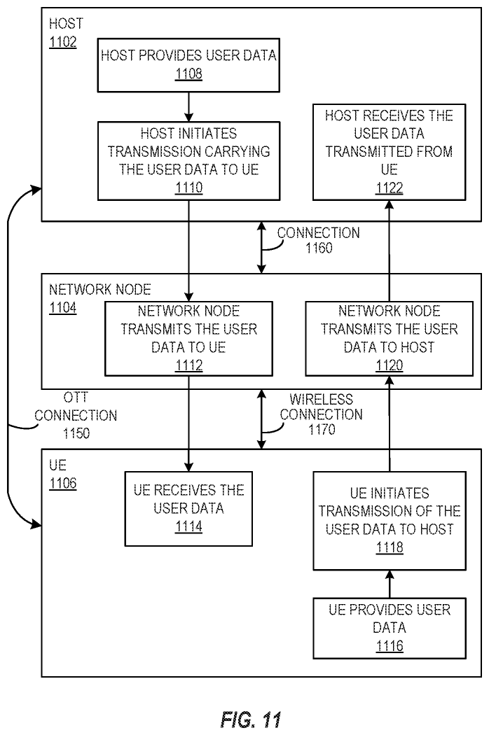

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

Some example embodiments of the present disclosure are as follows:

### Group A Embodiments

Embodiment 1: A method performed by a User Equipment, UE, the method comprising one or more of:
a. determining (400A) a PMI time unit and/or a number of PMI time units for which the UE is requested to feedback PMIs;
b. using (402A) a CQI time unit defined using the PMI time unit;
c. determining (404) an integer parameter for scaling the PMI time unit to derive the CQI time unit;
d. reporting (406A) one wideband CQI per CQI time unit;
e. reporting (408A) of a configured number of subband CQIs for a CQI time unit; and/or
f. reporting (410A) of a configured number of subband CQIs for a CQI time unit.

Embodiment 2: The method of the previous embodiment wherein the integer parameter may be signaled/configured/indicated by the gNB to the UE.

Embodiment 3: The method of any of the previous embodiments wherein the integer parameter may be selected and reported by the UE as part of CSI report.

Embodiment 4: The method of any of the previous embodiments further comprising determining the number of CQIs to report.

Embodiment 5: The method of any of the previous embodiments further comprising receiving from a network node the number of CQIs to report.

Embodiment 6: The method of any of the previous embodiments, further comprising: providing user data; and forwarding the user data to a host via the transmission to the network node.

### Group B Embodiments

Embodiment 7: A method performed by a network node, the method comprising one or more of:
a. transmitting (500A), e.g. to a user equipment, UE, a PMI time unit and/or a number of PMI time units for which a user equipment is requested to feedback PMIs and/or a number of CQIs to receive;
b. transmitting (502A) an integer parameter for scaling the PMI time unit to derive the CQI time unit;
c. receiving (504A) one wideband CQI per CQI time unit;
d. receiving (506A) a configured number of subband CQIs for a CQI time unit; and/or
e. receiving (508A) of a configured number of subband CQIs for a CQI time unit.

Embodiment 8: The method of the previous embodiment including any of the features of Group A. Embodiments.

Embodiment 9: The method of any of the previous embodiments, further comprising: obtaining user data; and forwarding the user data to a host or a user equipment.

### Group C Embodiments

Embodiment 10: A user equipment, comprising: processing circuitry configured to perform any of the steps of any of the Group A embodiments; and power supply circuitry configured to supply power to the processing circuitry.

Embodiment 11: A network node, the network node comprising: processing circuitry configured to perform any of the steps of any of the Group B embodiments; and power supply circuitry configured to supply power to the processing circuitry.

Embodiment 12: A user equipment (UE), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 13: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 14: The host of the previous embodiment, wherein the cellular network further includes a network node configured to communicate with the UE to transmit the user data to the UE from the host.

Embodiment 15: The host of the previous 2 embodiments, wherein: the processing circuitry of the host is configured to execute a host application, thereby providing the user data; and the host application is configured to interact with a client application executing on the UE, the client application being associated with the host application.

Embodiment 16: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 17: The method of the previous embodiment, further comprising: at the host, executing a host application associated with a client application executing on the UE to receive the user data from the UE.

Embodiment 18: The method of the previous embodiment, further comprising: at the host, transmitting input data to the client application executing on the UE, the input data being provided by executing the host application, wherein the user data is provided by the client application in response to the input data from the host application.

Embodiment 19: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 20: The host of the previous embodiment, wherein the cellular network further includes a network node configured to communicate with the UE to transmit the user data from the UE to the host.

Embodiment 21: The host of the previous 2 embodiments, wherein: the processing circuitry of the host is configured to execute a host application, thereby providing the user data; and the host application is configured to interact with a client application executing on the UE, the client application being associated with the host application.

Embodiment 22: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 23: The method of the previous embodiment, further comprising: at the host, executing a host application associated with a client application executing on the UE to receive the user data from the UE.

Embodiment 24: The method of the previous embodiment, further comprising: at the host, transmitting input data to the client application executing on the UE, the input data being provided by executing the host application, wherein the user data is provided by the client application in response to the input data from the host application.

Embodiment 25: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 26: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 27: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 28: The method of the previous embodiment, further comprising, at the network node, transmitting the user data provided by the host for the UE.

Embodiment 29: The method of any of the previous 2 embodiments, wherein the user data is provided at the host by executing a host application that interacts with a client application executing on the UE, the client application being associated with the host application.

Embodiment 30: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 31: The communication system of the previous embodiment, further comprising: the network node; and/or the user equipment.

Embodiment 32: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 33: The host of the previous 2 embodiments, wherein: the processing circuitry of the host is configured to execute a host application, thereby providing the user data; and the host application is configured to interact with a client application executing on the UE, the client application being associated with the host application.

Embodiment 34: The host of the any of the previous 2 embodiments, wherein the initiating receipt of the user data comprises requesting the user data.

Embodiment 35: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 36: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a network node, first signaling that indicates a precoding matrix duration in time domain;
receiving, from the network node, second signaling that indicates a number of precoder matrix durations wherein each precoder matrix duration is associated with a precoder matrix;
receiving, from the network node, third signaling that indicates one or more Channel Quality Indicator (CQI) resolutions in time domain for one or more CQIs;
reporting, to the network node, Precoding Matric Indicator (PMI) for the number of precoder matrix durations; and
reporting, to the network node, one or more CQIs according to the indicated one or more CQI resolutions in time domain.

2. The method of claim 1, wherein the third signaling is independent from the first signaling.

3. The method of claim 1, wherein the precoding matrix duration in time domain is defined in terms of an integer number of slots.

4. The method of claim 1, wherein each of the indicated one or more CQI resolutions in time domain is defined over two precoding matrix durations in time domain.

5. The method of claim 1, wherein reporting the one or more CQIs comprises reporting one wideband CQI for each of the indicated one or more CQI resolutions in time domain.

6. The method of claim 1, wherein reporting the one or more CQIs comprises reporting one wideband CQI and a plurality of subband CQIs for each of the indicated one or more CQI resolutions in time domain.

7. The method of claim 1, wherein each of the indicated one or more CQI resolutions in time domain is defined over the number of precoder matrix durations in time indicated by the second signaling.

8-14. (canceled)

15. A User Equipment (UE) comprising:
a communication interface; and
processing circuitry associated with the communication interface, the processing circuitry configured to cause the UE to:
receive, from a network node, first signaling that indicates a precoding matrix duration in time domain;
receive, from the network node, second signaling that indicates a number of precoder matrix durations wherein each precoder matrix duration is associated with a precoder matrix;
receive, from the network node, third signaling that indicates one or more Channel Quality Indicator (CQI) resolutions in time domain for one or more CQIs;
report, to the network node, Precoding Matric Indicator (PMI) for the number of precoder matrix durations; and
report, to the network node, one or more CQIs according to the indicated one or more CQI resolutions in time domain.

16. The UE of claim 15, wherein the third signaling is independent from the first signaling.

17. The UE of claim 15, wherein the precoding matrix duration in time domain is defined in terms of an integer number of slots.

18. The UE of claim 15, wherein each of the indicated one or more CQI resolutions in time domain is defined over two precoding matrix durations in time domain.

19. The UE of claim 15, wherein reporting the one or more CQIs comprises reporting one wideband CQI for each of the indicated one or more CQI resolutions in time domain.

20. The UE of claim 15, wherein reporting the one or more CQIs comprises reporting one wideband CQI and a plurality of subband CQIs for each of the indicated one or more CQI resolutions in time domain.

21. The UE of claim 15, wherein each of the indicated one or more CQI resolutions in time domain is defined over the number of precoder matrix durations in time indicated by the second signaling.

22. A method performed by a network node of a cellular network, the method comprising:
transmitting, to a User Equipment (UE), first signaling that indicates a precoding matrix duration in time domain;
transmitting, to the UE, second signaling that indicates a number of precoder matrix durations wherein each precoder matrix duration is associated with a precoder matrix;
transmitting, to the UE, third signaling that indicates one or more Channel Quality Indicator (CQI) resolutions in time domain for one or more CQIs;
receiving, from the UE, Precoding Matric Indicator (PMI) reported for the number of precoder matrix durations; and
receiving, from the UE, one or more CQIs reported according to the indicated one or more CQI resolutions in time domain.

23. The method of claim 22, wherein the third signaling is independent from the first signaling.

24. The method of claim 22, wherein the precoding matrix duration in time domain is defined in terms of an integer number of slots.

25. The method of claim 22, wherein each of the indicated one or more CQI resolutions in time domain is defined over two precoding matrix durations in time domain.

26. The method of claim 22, wherein receiving the one or more CQIs comprises receiving one wideband CQI for each of the indicated one or more CQI resolutions in time domain.

27. The method of claim 22, wherein receiving the one or more CQIs comprises receiving one wideband CQI and a plurality of subband CQIs for each of the indicated one or more CQI resolutions in time domain.

28. The method of claim 22, wherein each of the indicated one or more CQI resolutions in time domain is defined over the number of precoder matrix durations in time indicated by the second signaling.

29-30. (canceled)

31. A network node for a cellular network, the network node comprising processing circuitry configured to cause the network node to:
transmit, to a User Equipment (UE), first signaling that indicates a precoding matrix duration in time domain;
transmit, to the UE, second signaling that indicates a number of precoder matrix durations wherein each precoder matrix duration is associated with a precoder matrix;
transmit, to the UE, third signaling that indicates one or more Channel Quality Indicator (CQI) resolutions in time domain for one or more CQIs;
receive, from the UE, Precoding Matric Indicator (PMI) reported for the number of precoder matrix durations; and
receive, from the UE, one or more CQIs reported according to the indicated one or more CQI resolutions in time domain.

32. (canceled)
